(19) United States
(12) Patent Application Publication
(10) Pub. No.: US 2018/0144309 A1
(43) Pub. Date: May 24, 2018

(54) System and Method for Determining Valid Request and Commitment Patterns in Electronic Messages

(71) Applicant: Tony Rolle, Paris (FR)

(72) Inventor: Tony Rolle, Paris (FR)

(21) Appl. No.: 15/357,213

(22) Filed: Nov. 21, 2016

(51) Int. Cl. G06Q 10/10; H04L 12/58; G06F 17/24; G06F 17/22

(52) U.S. Cl. CPC G06Q 10/1097; G06F 17/2264; G06F 17/241; H04L 51/04

(57) ABSTRACT

A system and method are provided for comparing portions of text in electronic messages with potential request/commitment information components, determining if individual portions correspond to a request/commitment information component, and determining if a set of portions correspond to a valid request/commitment information pattern. A set of valid request/commitment information patterns is provided. Each request/commitment information pattern may include a specified combination of request/commitment information components. The invention further relates to identifying potential request/commitment information components from text in electronic messages, analyzing a pattern of the identified request/commitment information components by comparing the pattern to a set of stored request/commitment information patterns to determine if the potential request/commitment information is a type of request or commitment, and if so, is it a valid (and/or invalid) request/commitment information pattern. Once request/commitment information patterns have been determined in the electronic message, the identified request or commitment may be highlighted in the electronic message, added to a list of request/commitment information items or sent via SMS, electronic message, IM, TWITTER™, FACEBOOK™, SKYPE™, LINKED-IN™, mobile or desktop notification to a user's mobile device (e.g., phone, smartphone, smartwatch and other wearable technology or other push notification-enabled or SMS-enabled appliance). Once received, the user may have the ability to decide what action to take, if any, such as dismissing the notification, expanding the notification to display a list of task-related information items, opening the original application from where the email or social networking message originated or by deleting the notification.

### FIELD OF THE INVENTION

The invention relates to a system and method for determining valid request/commitment information patterns in electronic messages.

### BACKGROUND OF THE INVENTION

FIG. 1 is an exemplary illustration of a standard request (actionable utterance) found in an electronic message. A request may include a plurality of constituent components such as, for example: a modal word or phrase field and a task field.

It is an unfortunate but all too common occurrence, where a business executive who receives dozens or hundreds of electronic messages each day, where electronic messages containing important tasks, requests for information or questions fall through the cracks. Because electronic messages have become and remains the primary method of communication, both for business and personal use, it is understandable for a business executive to become overwhelmed by the sheer volume of information received on a daily basis. This is especially problematic in a business situation where a significant portion of an executive's day may be spent sorting through, responding to, searching for and classifying electronic messages.

As much of the text received in email consists of social pleasantries and background information, the entire electronic message could be boiled down into the one or two lines that contain the real purpose of the electronic message.

One way to assist a business executive in classifying electronic messages which contains requests or commitments would be to automatically identify request/commitments in electronic messages at the message level (marking electronic messages as requests if they contain one or more request utterances) or automatically identify requests/commitments in electronic messages at the sentence level. It is observed that, in the real world, a single electronic message may contain multiple requests/commitments.

The prior art has taught a method of classifying electronic messages which contains requests/commitments, such method being referred to as a request classifier. The request classifier is based around a support vector machine (SVM) classifier, implemented using Weka (a workbench which contains a collection of visualization tools and algorithms for data analysis and predictive modeling) or an implementation of the sequential minimal optimization algorithm. Given an electronic message as input, the binary request classifier can predict the presence or absence of task requests within the electronic message.

While training linear SVMs have proven effective in text categorization with large feature vectors, several drawbacks may be associated with use of the known art. For example, the most serious problem with SVMs is the high algorithmic complexity and extensive memory requirements of the required quadratic programming in large-scale tasks. Consequently, determining valid task-related information patterns in electronic messages may be time-consuming, depending on the length and complexity of the electronic message as well as the number and frequency of incoming electronic messages to be analyzed. Additionally, although SVMs have good generalization performance, they can be abysmally slow in the test phase. Hence, the use of SVMs in a commercial application in a business setting may result in unacceptable performance.

Accordingly, it is evident that the existing method using SVMs lack a consistent level of accuracy and speed in recognizing and identifying complex requests/commitments.

### SUMMARY OF THE INVENTION

The invention addressing these and other drawbacks of existing task focused email summarization applications relates to a system and method for comparing portions of electronic message text with potential request/commitment information components, determining if individual portions correspond to a request/commitment information component, and determining if a set of portions correspond to a valid request/commitment information pattern. For purposes of this document, a valid request/commitment information pattern may be defined as a request or commitment found in an electronic message which a user would typically add to a to-do list or a request or commitment found in an electronic message which places an obligation on the user to take action in some way. On the other hand, an invalid request/commitment information pattern may be defined as text found in an electronic message which may resemble a request or commitment but is not something the user would typically add to a to-do list.

According to one aspect of the invention, the system stores request/commitment information component criteria. For example, for each of a number of request/commitment information components, a set of request/commitment information component criteria may be provided. The request/commitment information component criteria may include various syntax rules and/or other criteria (such as superficial features including word unigrams, bigrams and trigrams and linguistic features including abstract lexical features such as part-of-speech bigrams and trigrams) for identifying characteristics of a particular request/commitment information component. According to one aspect of the invention, regular expressions may be used to define syntax rules for characterizing a request/commitment information component. The regular expressions may include individual characters, sets or sequences of characters, strings, words, terms, expressions, and combinations thereof, for describing patterns of text in an electronic message. Other tools and techniques may also be used.

According to one aspect of the invention, the system stores a set of valid request/commitment information patterns. Each request/commitment information pattern may include a specified combination of request/commitment information components, which together, define a pattern. According to one aspect of the invention, regular expressions may be used to define syntax rules for characterizing a request/commitment information pattern.

One aspect of the invention relates to identifying potential request/commitment information components from text in an electronic message, analyzing a pattern of the identified request/commitment information components by comparing the pattern to the set of stored request/commitment information patterns to determine if the potential request/commitment is a type of request or commitment, and if so, is it a valid request/commitment information pattern. According to one implementation, the pattern analysis determines whether the identified request/commitment information components are ordered, associated, adjacent, juxtaposed and/or otherwise related, in the manner according to one of the set of stored request/commitment information patterns. In some implementations, this may be a Boolean operation.

Once valid (and/or invalid) request/commitment information patterns have been identified in the electronic message, the identified request or commitment may be highlighted in the electronic message, added to a list of request/commitment information items or sent via SMS (Short Message Service), electronic message, IM (Instant Messaging), TWITTER™, FACEBOOK™, SKYPE™, LINKED-IN™, mobile or desktop notification to a user's mobile device (e.g., phone, smartphone, smartwatch and other wearable technology or other push notification-enabled or SMS-enabled appliance).

Once received, the user may have the ability to decide what action to take, if any, such as dismissing the notification, expanding the notification to display a list of task-related information items, opening the original application from where the electronic message or social networking message originated or by deleting the notification.

According to one aspect of the invention, a software application may provide various modules for performing the above-mentioned tasks. The software application may include: a graphical user interface module; a storage module; a request/commitment information processing module that may further include a request/commitment information component identification module, a request/commitment information component pattern matching module, an action item module; a task list generator module; a notification module and an interface module.

According to one aspect of the invention, the graphical user interface module controls the various display features of the application and allows the user to interact with the application using a computer.

According to one aspect of the invention, the storage module maintains the set of request/commitment information components along with their associated sets of request/commitment information component criteria. In addition, the storage module contains the set of request/commitment information patterns along with the associated set of request/commitment information components.

The request/commitment information processing module may include a request/commitment information component identification module to analyze text in an electronic message and identify portions of text, which correspond to one or more stored request/commitment information components which may be found in the electronic message. In addition, the request/commitment information processing module may include a request/commitment information component pattern matching module that analyzes a pattern of the identified request/commitment information components by comparing the pattern to a set of stored request/commitment information patterns to determine if the potential request/commitment is a type of request/commitment, and if so, is it a valid request/commitment information pattern.

According to one aspect of the invention, the request/commitment information processing module may maintain an index of the valid request/commitment information patterns determined in the text of the electronic message.

According to one aspect of the invention, an annotation module may be provided which generates computer readable indicators and/or visual indicators corresponding to portions of text determined to be valid (and/or invalid) request/commitment information patterns. One or more computer readable indicators, such as field codes, hidden codes, flags, or other indicators, may be used that signal to the software application that that portion of text is a valid request/commitment information pattern. Similarly, one or more visual indicators which may include a change of font (e.g., underlining, italics, size, font type, color, shading, highlighting or other font parameter), an icon, a symbol and/or the presence or absence of other indicia that visually signal to a user that that portion of text is a valid (and/or invalid) request/commitment information type. In some implementations, a computer readable indicator and a visual indicator may be the same. Also, in some implementations, different indicators may be provided depending on the type of request/commitment. In one implementation, the same indicator may be used for valid request/commitment information patterns corresponding to the same request/commitment in order to signal to the application (and/or the user) that those request/commitment information patterns are related.

According to one aspect of the invention, an action item module may be provided that allows the user to select various options associated with each valid (and/or invalid) request/commitment information pattern. The options may be static, dynamic, or customized based on different request/commitment information types. In one implementation, an information icon, which provides a drop-down action menu when the uses clicks on or hovers over the icon, may be provided. Various options may be presented to the user within the drop-down action menu, according to the type of request/commitment associated therewith. Such actions may include, but are not limited to, an option to add the request/commitment to a to-do list or to an electronic calendar, create an electronic post-it note, assign the request/commitment to another user or create a reminder.

According to one aspect of the invention, the software application may also include a list generator module to generate a list of the valid request/commitment information patterns determined in the electronic message. The list of request/commitment information items may include, for example, a table, a chart, a list, or other summarizing feature for request/commitment information items. The list generator module may rely on the computer readable (or visual) indicators which were previously inserted by the annotation module and/or the index of request/commitment information items maintained by the request/commitment information processing module, and/or the index of request/commitment information items.

According to one aspect of the invention, an interface module may be provided to allow the software application to connect to various devices, as needed, thereby allowing the software application to transmit and/or receive information and data there between. The interface module may be configured to connect via the network to an external device such as a user's mobile device (e.g., phone, smartphone, smartwatch and other wearable technology or other push notification-enabled or SMS-enabled appliance) via SMS, electronic message, IM, TWITTER™, FACEBOOK™ SKYPE™, LINKED-IN™, mobile or desktop notification.

According to one aspect of the invention, a method is provided for determining valid request/commitment information patterns in an electronic message. First, the software application opens and/or processes an electronic message. A user may interact with the electronic message through the graphical user interface module. The Electronic messages may comprise electronic messages generated by any of a number of software applications (e.g., word processing applications, email applications, messaging applications, web-browsing applications or other software applications).

Next, the request/commitment information processing module scans text in the electronic message and identifies portions of text, which correspond to one or more stored request/commitment information components which may be found in the electronic message. The request/commitment information component identification module initially compares portions of text in the electronic message against the set of stored request/commitment information component criteria, to determine potential request/commitment information components in the electronic message text. Then, the request/commitment information component pattern matching module determines whether a pattern of the identified request/commitment information components matches a stored request/commitment information pattern. The pattern analysis determines whether the identified request/commitment information components are ordered, associated, adjacent, juxtaposed and/or otherwise related, in a manner according to one of the stored request/commitment information patterns.

For those request/commitment information items which are determined to be valid request/commitment information patterns, annotations may be inserted into the electronic message by the annotation module. The annotations signal to the software application (and/or the user) that one or more valid request/commitment information patterns are located in the electronic message text. Each valid request/commitment information pattern may be individually identified in the electronic message text. The annotation module may generate computer readable indicators and/or visual indicators corresponding to portions of text determined to be valid request/commitment information patterns.

According to one aspect of the invention, once valid (and/or invalid) request/commitment information patterns have been identified in the electronic message text, subsequent action may be taken by the software application and/or the user. For example, the user may select various options and/or functions associated with each valid request/commitment information pattern. In one implementation, an information icon, which provides a drop-down action menu when the user clicks on or hovers over the icon, may be provided for each valid request/commitment information pattern in the electronic message. Various options may be presented to the user within the drop-down action menu, according to the type of request/commitment associated therewith. Such actions may include, but are not limited to, an option to add the request/commitment to a to-do list or to an electronic calendar, create an electronic post-it note, assign the request/commitment to another user or create a reminder.

According to one aspect of the invention, a list of request/commitment information items may be generated and inserted within the host software application (or other location), automatically or at the direction of the user, by the list generator module.

The user may select the location and the type of list to generate, for example, from a menu. The list of request/commitment information items may include, for example, a table, a chart, a list, or other summarizing feature for request/commitment information items. Alternatively, the software application may automatically generate the list of request/commitment information items on a user's mobile device (e.g., phone, smartphone, smartwatch and other wearable technology or other push notification-enabled or SMS-enabled appliance) via SMS, electronic message, IM, TWITTER™, FACEBOOK™, SKYPE™, LINKED-IN™, mobile or desktop notification based on default parameters, when the user selects an option to do so. In generating a list of request/commitment information items, the list generator module may rely on the computer readable indicators that were previously inserted by the annotation module and the index of valid request/commitment information patterns determined in the electronic Message.

Other features and advantages of the invention will be apparent from the following detailed description and accompanying drawings, figures and the appended claims.

### BRIEF DESCRIPTION OF THE DRAWINGS

These and other features and advantages of the present invention will become more readily appreciated as the same becomes better understood by reference to the following detailed description when considered in connection with the accompanying drawings, wherein:

FIG. 1 is an exemplary illustration of a basic request/commitment information pattern item which may be found in an electronic message;

FIG. 2 is intentionally omitted;

FIG. 3 is intentionally omitted;

FIG. 4 is intentionally omitted;

FIG. 5 illustrates an exemplary system architecture, according to one aspect of the invention;

FIG. 6 is a schematic block diagram of a computer, according to one aspect of the invention;

FIG. 7 is an exemplary illustration of a software application, according to one aspect of the invention;

FIG. 8 illustrates how a set of request/commitment information component criteria may be used to identify a request/commitment component, according to an aspect of the invention;

FIG. 9 illustrates how a set of request/commitment information components may be used to determine a request/commitment information pattern, according to an aspect of the invention;

FIG. 10 illustrates an exemplary request/commitment information item and how the request/commitment information components in FIG. 8 may correspond thereto;
and

FIG. 11 illustrates a flowchart of processing operations for demonstrating how valid request/commitment information patterns may be determined within the text of an electronic message, according to one aspect of the invention.

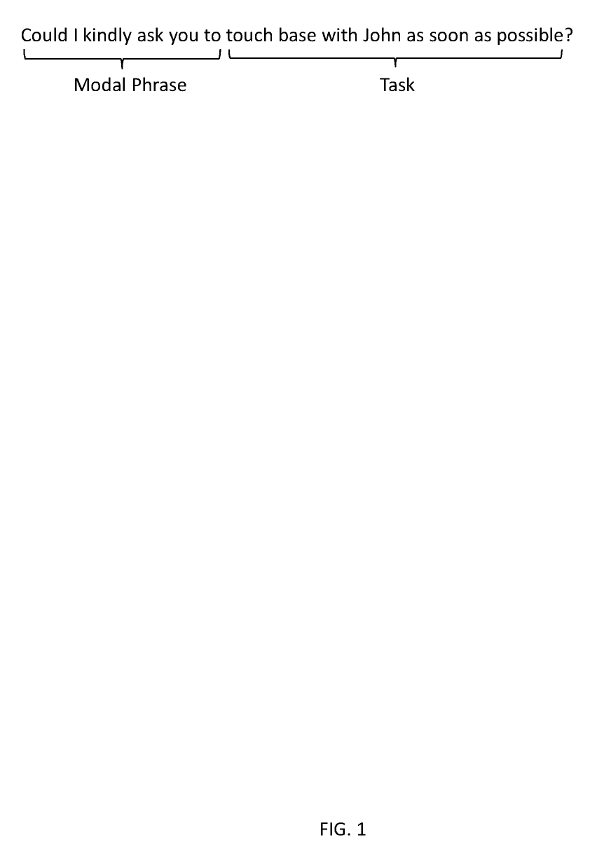

### DETAILED DESCRIPTION OF THE INVENTION

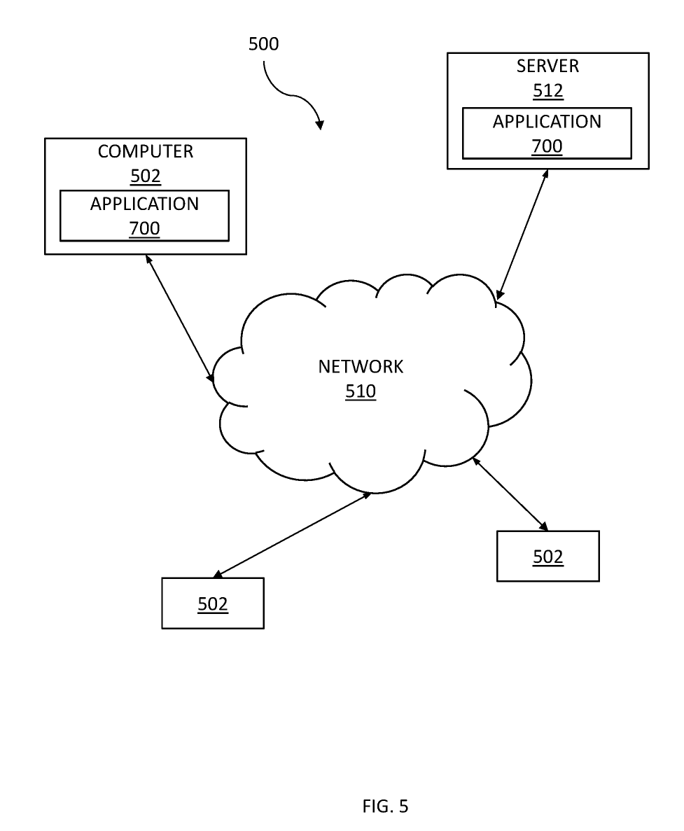

According to an aspect of the invention, and with reference to FIG. 5, an exemplary system architecture 500 will first be described. In one implementation, a user may create, send, receive, manipulate, or store one or more electronic messages of varying file type via a computer 502. Computer 502 may comprise, but is not limited to, a desktop computer, portable computer (e.g., a laptop computer), network-enabled appliance, mobile device or other device. According to one aspect of the invention, a software application 700 may be provided for determining valid request/commitment information patterns in electronic messages, which may be executed by a processor of computer 502.

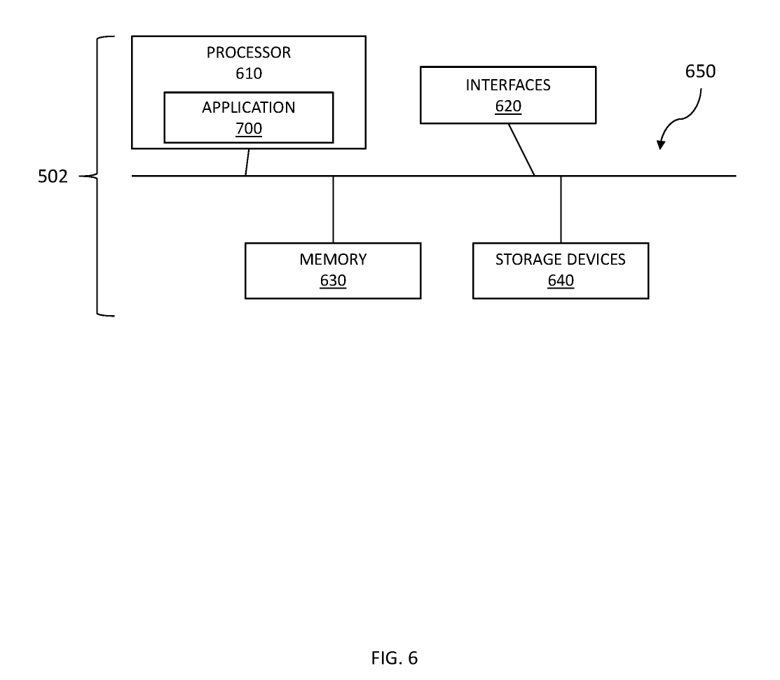

In one implementation, and with reference to FIG. 6, computer 502 may comprise a processor 610, interfaces 620, memory 630, and storage devices 640 which are electrically coupled via bus 650. Memory 630 may comprise random access memory (RAM), read only memory (ROM), flash memory, or other memory, and may store computer-executable instructions to be executed by processor 610, as well as data which may be manipulated by processor 610. Storage devices 640 may comprise floppy disks, hard disks, optical disks, tapes, or other known storage mediums for storing computer-executable instructions and/or data. Interfaces 620 may comprise interfaces to various peripheral devices (e.g., a keyboard, a mouse, microphones, external storage devices, monitors, printers or other input and/or output devices as would be appreciated by those having skill in the art) as well as other components as described herein.

According to an aspect of the invention, a user may run any number of various types of software applications on computer 502. In some implementations, a user may utilize computer 502 to access any number of various types of software applications hosted, including application 700, for example, by one or more servers, such as server 512. In some implementations, computer 502 may be networked directly to server 512, or operatively connected to server 512 over a network 510, via a wired or wireless communications link. Network 510 may include any one or more of, for instance, the Internet, an intranet, a Personal Area Network (PAN), a Local Area Network (LAN), a Wide Area Network (WAN), a Storage Area Network (SAN), a Metropolitan Area Network (MAN), or other network. Any suitable communications link may be utilized, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, wireless connection, or other connection. Although not illustrated, server 512 may comprise, include, and/or interface to one or more databases or other data storage or query formats, platforms, or resources for storing (and retrieving) various types of data.

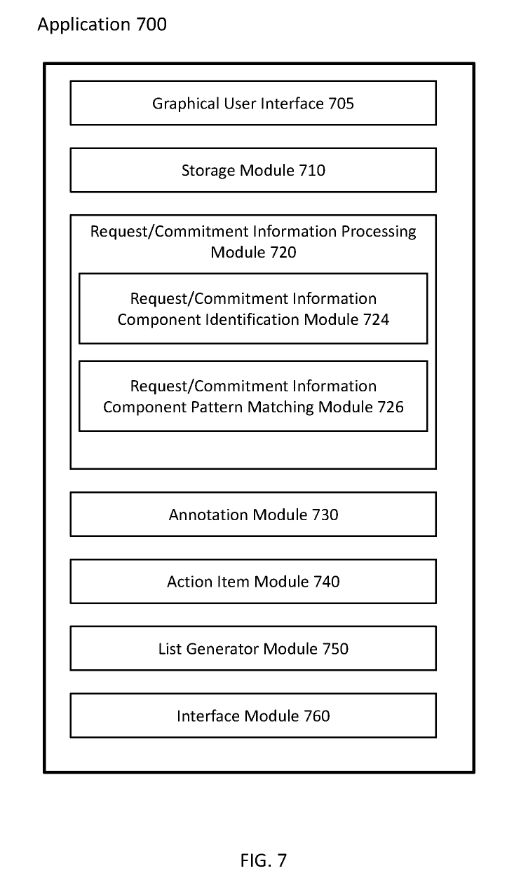

According to an aspect of the invention, FIG. 7 shows a software application 700 that may be provided for determining valid request/commitment information patterns in electronic messages. The electronic messages may comprise electronic messages associated with any number of software applications (e.g., word processing applications, email applications, messaging applications, web-browsing applications, or other software applications).

According to an aspect of the invention, and with reference to FIG. 7, application 700 may comprise one or more software modules that enable the various features and functionality of the invention. Non-limiting examples of the modules of application 700 may include: a graphical user interface module 705, a storage module 710, a request/commitment information processing module 720 which may further include a request/commitment information component identification module 724 and a request/commitment information component pattern matching module 726, an annotation module 730, an action item module 740, a request/commitment information item list generator module 750, and an interface module 760.

One or more of the modules comprising application 700 may be combined.

For some purposes, not all modules may be necessary.

According to an aspect of the invention, application 700 may be created using any number of programming languages including, but not limited to, Visual Basic.Net, or Visual C#.Net. Of course, any number of hardware implementations, programming languages, and operating platforms may be used without departing from the spirit or scope of the invention. As such, the description or recitation of any specific hardware implementation, programming language, and operating platform herein is exemplary only and should not be viewed as limiting.

The graphical user interface module 705 controls the various display features of the application and allows the user to interact with the application using a computer 502. The graphical user interface module 705 may interact with the computer's operating system and/or one or more software applications. In one implementation, application 700 may comprise a stand-alone software application running on computer 502.

Alternatively, server 512 may host application 700, thus requiring a user of computer 502 to access server 512 over network 510 to use the application. In some implementations, a user may download application 700 from server 512 to be run on computer 502, with program updates made available (over network 510) as needed, or on a predetermined, regularly-scheduled basis.

In an alternative implementation, application 700 may be a “plug-in” that is incorporated into a third-party software application including, for example, but not limited to, a word-processing application, an email application, a messaging application, web-browsing application or other application. The third-party software application may comprise an application running on computer 502, or an application hosted by (or downloaded from) server 512 (via network 510). Other configurations may be implemented.

According to one aspect of the invention, each request/commitment information pattern is composed of various request/commitment information components. For each of a number of request/commitment information components, a set of request/commitment information component criteria may be provided. According to one aspect of the invention, the request/commitment information components may be in a language other than English.

In one implementation, the application may be used with electronic messages containing request/commitment information in German, French, Italian, Spanish, Chinese or any other language.

According to one implementation, regular expressions may be used to define syntax rules for characterizing request/commitment information components and request/commitment information patterns. For example, several computer languages and utilities—including UNIX utilities, Perl, grep, .NET, and Java—recognize regular expressions (or “regex”). However, other tools and techniques may also be used.

Table 1 illustrates some regular expression syntaxes that may be used to define syntax rules for characterizing request/commitment information components, according to an aspect of the invention. The regular expressions may include individual characters, sets or sequences of characters, strings, words, terms, expressions, and combinations thereof, for describing patterns of text in an electronic message.

TABLE 1 Common Syntaxes of Regular Expressions Syntax Definition \ indicates next character should not be interpreted literally (general escape character) ^ beginning of input or line $ end of input or line * 0 or more instances of preceding character +1 or more instances of preceding character ? 0 or 1 instance of preceding character .any single character other than the new line character [start character class definition|start alternate (start of subpattern {Start minimum/maximum quantifier (x) x and remembers the match x|y either x or y {n} exactly n instances of preceding character (where n is an integer) {n,} at least n instances of preceding character (where n is an integer) {n,m} at least n and at most m instances of preceding character (where n and m are integers) [xyz] any one of enclosed characters (specify range using hyphen, such as [0-9] [^xyz] any character not enclosed (specify range using hyphen, such as [^0-9] [\b] a backspace \b a word boundary, such as a space \B a non-word boundary \cX a control character, X\d a digit character (same as [0-9]) \D a non-digit character (same as [^0-9]) \f a form feed \n a line feed \r a carriage return \s a single white space character, including space, tab, form feed, and line feed (same as [\f\n\r\t\v]) \S a single non-white-space character (same as [^\f\n\r\t\v]) \t a tab \va vertical tab \w any alphanumeric character, including the underscore (same as [A-Za-z0-9]) \W any non-word character (same as [^A-Za-z0-9_]) \n a reference to the last substring matching the nth parenthetical (where n is a positive integer) \ooctal an octal or hexadecimal escape value \xhex (for embedding ASCII codes).

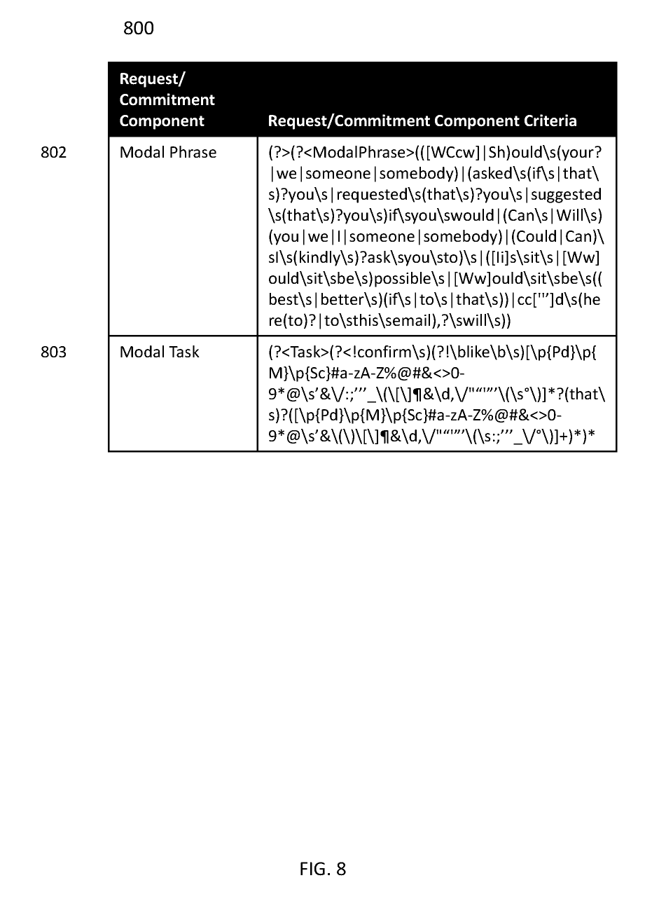

FIG. 8 shows, in one implementation, how the syntaxes in Table 1 may be used to create a set of request/commitment information component criteria for each of a plurality of request/commitment information components. It will be appreciated that many more syntax members exist other than those depicted in Table 1.

As previously mentioned, the request/commitment information components may be created for any desired request/commitment information format, and only a few possible examples are shown herein. According to one aspect of the invention, the set of request/commitment information component criteria may include various syntax rules and/or other criteria for identifying characteristics of a particular request/commitment information component. In FIG. 8, each of entries 802-803 in Table 800 denotes a request/commitment information component (first column) and its associated set of request/commitment information component criteria (second column).

Different request/commitment information types may use different combinations of request/commitment information components. However, not every combination of components may be, in fact, a valid request/commitment information pattern.

According to one implementation, a basic request/commitment information pattern may include, for example, a modal phrase request/commitment information component and a task request/commitment information component. These components of a request/commitment information item may be reflected in the construction of a pattern of request/commitment information components.

Entry 802 is an exemplary illustration of modal phrase request/commitment information component using many of the syntaxes in Table 1. According to its request/commitment information component criteria, the modal phrase may define an auxiliary (helping) verbs that is used to express: ability, possibility, permission or obligation along with the preposition to.

Entry 803 is an exemplary illustration of a task request/commitment information component using many of the syntaxes in Table 1. According to its request/commitment information component criteria, the task may define a task comprised of one or more words beginning with lower case letters or numbers. This request/commitment information component criteria also denotes certain lower case articles and prepositions which may be permitted to appear in a task field. In one implementation, this request/commitment information component criteria may include a construct which performs a “lookahead.” A lookahead (which may be identified with the “?=pattern” syntax) effectively allows a regular expression to peek ahead at subsequent characters. In this case, the lookahead may check to determine if the next characters are:

(1) a period, (2) a question mark, or (3) an exclamation point.

In one implementation, one or more of the request/commitment information components 802-803 form a request/commitment information pattern. Depending upon the specified combination of request/commitment information components, a request/commitment information pattern may become fairly extensive. Moreover, it will be appreciated that a request/commitment information pattern may not require all of the request/commitment information components in Table 800 (FIG. 8). In some implementations, one or more of the request/commitment information components may be optional or supplemental, used as alternatives, or may not even be used at all.

In some implementations, a request/commitment information component may be comprised of one or more other request/commitment information components. Likewise, a request/commitment information pattern may be comprised of one or more other request/commitment information patterns. Once created the request/commitment information components and request/commitment information patterns may be used again and again, in various ways by the application 700.

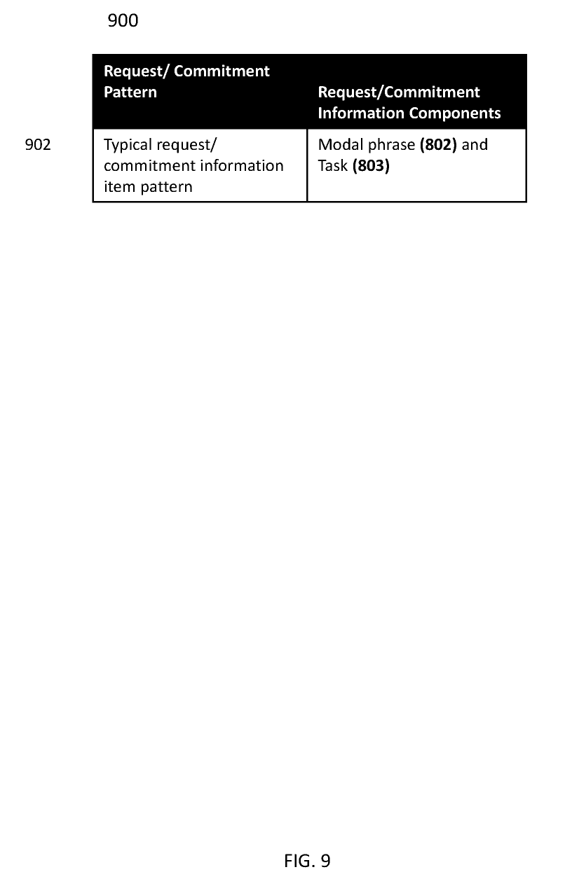

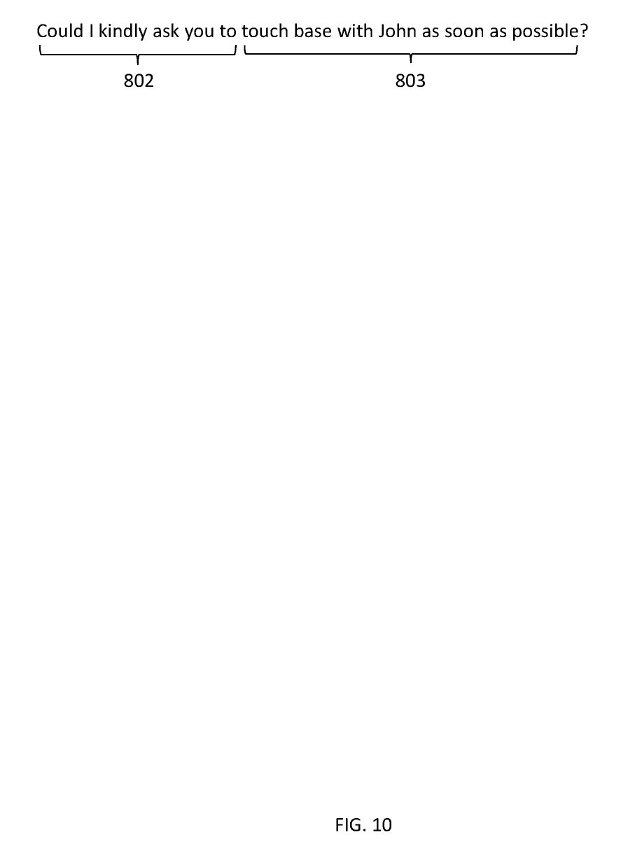

According to an aspect of the invention, and with reference to FIG. 9, each request/commitment information pattern may include a specified combination of one or more request/commitment information components. In one implementation, each of entries 902-903 in Table 900 (FIG. 9) corresponds to a request/commitment information pattern (first column) and a specified set of request/commitment information components (second column).

According to one aspect of the invention, each request/commitment information pattern includes not only its constituent request/commitment information components, but it also defines a pattern of those request/commitment information components. In one implementation, the set of request/commitment information components define a particular pattern between ordered, adjacent, associated, juxtaposed and/or otherwise related request/commitment information components that must occur in the text to have a valid request/commitment information pattern, for that type of request/commitment information item. In some implementations, each request/commitment information pattern may be characterized by a regular expression, formed by combining the regular expressions corresponding to its constituent request/commitment information components into a single regular expression. For example, when combining regular expressions, each regular expression may be separated by parentheses (for denoting the start and end of a subpattern), and/or other regular expression syntaxes, as desired (e.g., a ‘7’ before the parentheses may indicate that a request/commitment information component is optional or supplemental).

Entry 902 in Table 900 (FIG. 9) is an exemplary illustration of a typical request/commitment information item pattern, which may include a set of request/commitment information components that would be used to specify a request/commitment information item.

According to one implementation, a typical request/commitment information item pattern 902 may include the following set of request/commitment information components: modal phrase 802 and task 803.

In one implementation, the storage module 710 maintains one or more request/commitment information patterns along with their associated sets of request/commitment information components. The storage module 710 also maintains a set of request/commitment information component criteria for each request/commitment information component. Storage module 710 may include one or more separate files, tables, databases, or other electronic data storage means, maintained on one or more storage devices 640 of computer 502.

According to one aspect of the invention, the request/commitment information processing module 720 scans text in an electronic message to determine potential request/commitment information items therein. The request/commitment information processing module 720 may include a request/commitment information component identification module 724 that analyzes text in an electronic message and identifies portions of text that correspond to one or more stored request/commitment information components which may be found in the electronic message. In some implementations, the comparison may be a Boolean operation.

In one implementation, the request/commitment information component identification module 724 may begin at the first character of the electronic message and continue character-by-character until the end of the electronic message. In other implementations, the request/commitment information component identification module 724 may start at the beginning of the electronic message and proceed only to the end of the text contained in that portion of the electronic message which the sender has composed, ignoring any text in forwarded portion of the electronic message, if any exist. According to one implementation, the portions of text which match the request/commitment information component criteria may be “marked” (or otherwise identified) in memory 630 as a request/commitment information component.

According to one aspect of the invention, the request/commitment information processing module 720 may also include a request/commitment information component pattern matching module 726 that analyzes a pattern of the identified request/commitment information components (identified by the request/commitment information component identification module 724) by comparing the identified pattern to a set of stored request/commitment information patterns. In some implementations, the comparison may be a Boolean operation. According to one implementation, the identified request/commitment information components in the electronic message text which match the stored request/commitment information pattern may be marked in memory 630 as a valid request/commitment information pattern.

According to one aspect of the invention, the request/commitment information processing module 720 may maintain an index of valid request/commitment information patterns determined in the electronic message text. In one implementation, the request/commitment information processing module 720 may utilize a hashtable for the index. A hashtable is a data structure which contains an array of values for each of the entries therein. Each entry in the index may correspond to a request/commitment information item in the electronic message. For example, the request/commitment information processing module 720 may search the index with respect to valid request/commitment information patterns determined by the request/commitment information component pattern matching module 726 to determine whether that request/commitment information item component has previously been indexed. If not, a new entry may be created. In some implementations, the request/commitment information processing module 720 may alert the user to multiple occurrences of the same request/commitment information item in the electronic message text.

According to one implementation, the application may work in close cooperation with the Microsoft .NET Framework. In the Microsoft .NET Framework, regular expression support is provided by over half a dozen classes as part of the System.Text.RegularExpressions namespace. Three of these classes are illustrated in Table 2 below and may be utilized for tasks that involve regular expressions.

The application, when implemented, for example, within Microsoft Outlook®, recognizes request/commitment information components and request/commitment information patterns within an electronic message. According to one implementation, the Microsoft .NET Framework includes a regular expression engine which may be utilized to match regular expressions with portions of electronic message text. The Microsoft .NET Framework, for example, may read in a regular expression, corresponding to the request/commitment information patterns and request/commitment information components, from the storage module 710 into the memory 630 and/or one or more storage devices 640 of the computer 502. .NET performs matching in a top-to-bottom sequence. However, other regular expression engines may handle regular expressions in a different manner.

TABLE 2 .Net classes that support regular expressions Class Description Regex Represents a read-only regular expression and provides static methods for using regular expressions. Match Represents the result of a matching operation (when a regular expression is applied to an input string). MatchCollection Represents a sequence of successful matching operations (for example, when a regular expression matches several substrings within the input string).

In other implementations, the Match or MatchCollection classes do not need to be called directly by the programmer because the underlying VSTO architecture takes care of the pattern-matching. The programmer simply provides the regular expression and .NET (which includes the regular expression engine) takes care of matching text in the electronic message with the regular expression.

Thus, instead of performing the SVM training procedure, a one-to-one comparison between each request/commitment information component criteria and the electronic message text is performed to identify relevant portions of text matching the one or more request/commitment information components. Similarly, the application analyzes a pattern of the identified request/commitment information components by comparing the pattern to one of more stored request/commitment information patterns.

According to one aspect of the invention, and with reference to FIG. 10, an exemplary request/commitment information item is shown along with how the request/commitment information components in FIG. 8, which define the typical request/commitment information pattern 902, may correspond thereto.

As illustrated in FIG. 10, the request/commitment information components corresponding to the typical request/commitment information item satisfy the sets of request/commitment information component criteria for the request/commitment information components 802 and 803.

Thus, a generally accepted grammatical rule may be enforced by using an appropriate set of request/commitment information component criteria for each request/commitment information component. As a result, malformed or invalid request/commitment information patterns in electronic messages, which do not conform to the set of request/commitment information components for a particular request/commitment information pattern, may be ignored.

According to one aspect of the invention, the annotation module 730 may generate annotations corresponding to portions of text determined to be valid (and/or invalid) request/commitment information patterns. In one implementation, one or more computer readable indicators, such as field codes, hidden codes, flags, or other indicators, may be used that signal to the software application that that portion of text is a valid request/commitment information pattern. Similarly, one or more visual indicators which may include a change of font (e.g., underlining, italics, size, font type, color, highlighting, shading or other font parameter), an icon, a symbol and/or the presence or absence of other indicia that visually signal to a user that that portion of text is a valid request/commitment information item type. In some implementations, the computer readable indicator and the visual indicator may be the same. According to one aspect of the invention, the annotation module 730 may associate valid request/commitment information patterns according to entries in the index of request/commitment information maintained by the request/commitment information processing module 720.

Conversely, in other implementations, if the identified set of request/commitment information components is not determined to be a valid request/commitment information pattern, but otherwise, “appears” to correspond to a stored request/commitment information pattern (i.e., some, but not all of request/commitment information components of a particular request/commitment information pattern are satisfied), it may be flagged or otherwise identified by the annotation module 730 for error-handling.

According to one aspect of the invention, the annotation module 730 may insert a computer readable indicator into the electronic message text to indicate an invalid request/commitment information pattern. When a list of tasks is generated by the list generator module 750, these invalid request/commitment information patterns may be listed under the error category subheading in the list of request/commitment information items. In another implementation, those portions of text may be copied to a separate file.

According to one aspect of the invention, the action item module 740 allows the user to select various options and functions associated with each valid (and/or invalid) request/commitment information pattern. The options may be static, dynamic, or customized based on different request/commitment information types.

In one implementation, an information icon, which provides a drop-down action menu when the user clicks on or hovers over the icon, may be provided. The information icon may be associated with a computer readable indicator, such as a smart tag, that may be inserted by the annotation module 730. Various options may be presented to the user within the drop-down action menu, according to the type of request/commitment information associated therewith. Such actions may include, but are not limited to, an option to add the request/commitment to a to-do list or to an electronic calendar, create an electronic post-it note, assign the request/commitment to another user or create a reminder.

According to one aspect of the invention, the software application 700 may include a list generator module 750 to generate a list of the valid request/commitment information patterns identified in the electronic message. The list of request/commitment information items may include, for example, a table, a chart, a list, or other summarizing feature for request/commitment information items.

In one implementation, the list generator module 750 may use the annotations inserted into the electronic message by the annotation module 740 to generate a list of request/commitment information items and/or the index of request/commitment information items maintained by the request/commitment information processing module 720. For example, a task or to-do list may be generated. The list generator module 750 may associate a particular category with one or more type of request/commitment information. In some implementations, the annotation module 730 may insert a computer readable indicator for a particular type of request/commitment information item, which the list generator module 750 associates with a particular category of the task or to-do list.

According to one aspect of the invention, the interface module 760 allows the software application to connect to various devices, as needed, to transmit and/or receive information and data there between. The interface module 760 may be configured to connect via the network 510 to the server 512, such as a third-party external server. The interface module 760 may be configured to connect via the network 510 to an external device such as a user's mobile device (e.g., phone, smartphone, smartwatch and other wearable technology or other push notification-enabled or SMS-enabled appliance) via SMS, electronic message, IM, TWITTER™, FACEBOOK™ SKYPE™, LINKED-IN™, mobile or desktop notification.

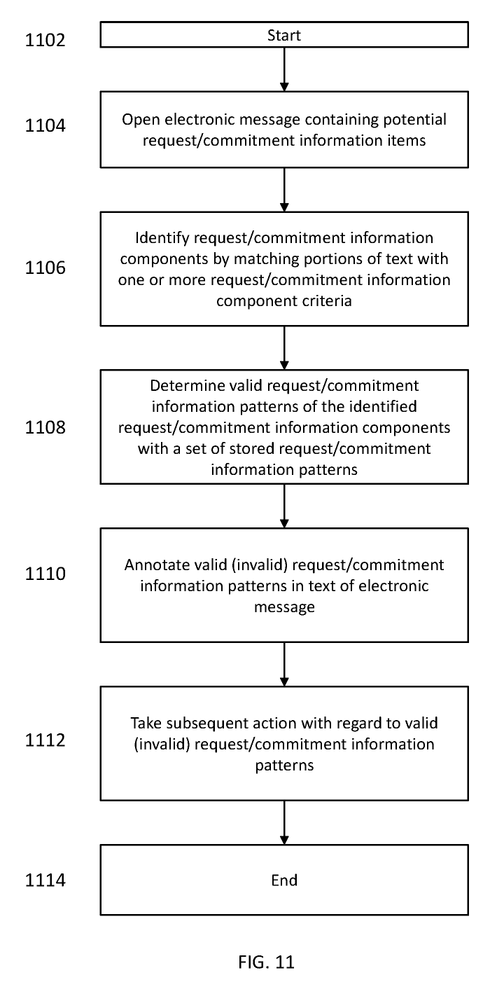

FIG. 11 is an exemplary flowchart of processing operations illustrating how valid request/commitment information patterns may be determinate from text in an electronic message. Processing may commence in an operation 1102. The user may interact with the application through the graphical user interface module 705.

In an operation 1104, an electronic message containing request/commitment information is opened in an application. The electronic message may comprise an electronic message generated by any of a number of software applications (e.g., word processing applications, email applications, messaging applications, web-browsing applications or other software applications). For example, users may open an electronic message or create a new electronic message from a template just as they would open any other electronic message.

In an operation 1106, request/commitment information components are identified in the electronic message text by matching portions of the text with one or more request/commitment information component criteria. First, a set of request/commitment information patterns and request/commitment information components along with their associated sets of request/commitment information component criteria and may be retrieved from the storage module 710 and transferred (or copied) to memory 630 of computer 502 for faster processing. Next, the request/commitment information processing module 720 scans the electronic message text. The electronic message text may be initially compared against one or more sets of request/commitment information component criteria by the request/commitment information component identification module 724. In one implementation, a one-to-one comparison may be made using a simple Boolean operation. If a portion of text matches a request/commitment information component criteria then that portion of text may be identified in memory 630 as a request/commitment information component, and may include information indicating the type of the request/commitment information component.

In an operation 1108, the request/commitment information component pattern matching module 726 analyses a pattern of the identified request/commitment information components (identified in operation 1106) by comparing the pattern to the set of stored request/commitment information patterns. The portions of text which are determined to be valid (and/or invalid) request/commitment information patterns may be stored in memory 630, and may include information indicating the type of the request/commitment information. As valid request/commitment information patterns are determined, they may be added to the index of request/commitment information items maintained by the request/commitment information processing module 720.

In some implementations, operations 1106 and 1108 may be performed in a simultaneous manner. In other implementations, operations 1106 and 1108 may be sequentially and/or iteratively performed.

In operation 1110, both valid (and/or invalid) request/commitment information patterns recognized in the electronic message text in operation 1108 may be annotated. The annotation module 730 generates computer readable indicators and/or visual indicators corresponding to portions of text determined to be valid request/commitment information patterns. Different indicators may be provided depending on the type of request/commitment information. In operation 1112, subsequent actions may be taken by the user and/or the application 700 once valid (and/or invalid) request/commitment information patterns have been determined in the electronic message. Subsequent actions may include adding the request/commitment to a to-do list or to an electronic calendar, creating an electronic post-it note, assigning the request/commitment to another user or creating a reminder. The processing ends in operation 1114.

The application may achieve near pinpoint accuracy in recognizing request/commitment information patterns in electronic message text. The application may advantageously perform these actions without any intervention on the part of the user. Thus, the system may require less human intervention than existing software applications to assist in finding and completing request/commitment information items.

This discussion is focused on reminding a user of messages within an e-mail system or environment; however, the present invention is not so limited and may be applied to other social networking systems, such as messages (e.g., tweets) in TWITTER™. or status messages or wall posts in FACEBOOK™. or LINKEDIN™ and the like.

As can be appreciated from the foregoing, implementations of the application provide for a more effective and efficient method of identifying request/commitment information items. The application is able to determine relevant portions of electronic message text faster or more accurately. In the existing software applications, the process of identifying request/commitment information may involve a long and complex process of training an SVM involving tens of thousands of terms. By contrast, using a set of request/commitment information patterns, only a minimum number of comparisons may be needed to identify a request/commitment information item.

Moreover, long and complex code associated with SVM algorithms may be eliminated and updates to a request/commitment information pattern may be made faster and more manageable. Changes may only need to occur to an individual request/commitment information component and/or request/commitment information pattern instead of multiple lines of code. Thus, the application may be able to determine relevant portions of electronic message text much more efficiently.

While this invention has been described in connection with what is presently considered to be the most practical and preferred embodiment, it is to be understood that it is capable of further modifications and is not to be limited to the disclosed embodiment, and this application is intended to cover any variations, uses, equivalent arrangements or adaptations of the invention following, in general, the principles of the invention and including such departures from the disclosure as come within known or customary practice in the art to which the invention pertains, and as may be applied to the essential features hereinbefore set forth and followed in the spirit and scope of the appended claims.

1. A computer implemented method for identifying request/commitment information in an electronic message, comprising:
searching content of a plurality of electronic messages for request/commitment information on a continuing scheduled basis, the plurality of messages comprising a message or a post in a social networking environment;
identifying, by a computer, valid request/commitment information patterns in text in a user's messages;
highlighting the identified request/commitment information based on the content of the plurality of messages;
monitoring, by a method selected from the group consisting of computer, message, and email analysis of the user to determine whether the user has responded to or otherwise acknowledged electronic messages containing identified request/commitment information;
reminding, by a computer, the user of at least one electronic message
comprising request/commitment information (if such request/commitment information has not been determined to have been responded to or otherwise acknowledged) via push notification, IM or SMS on the user's mobile device (e.g., phone, smartphone, smartwatch and other wearable technology or other push notification-enabled appliance) or via electronic message or desktop notification.

2. The computer implemented method of claim 1, wherein searching content of a plurality of messages for request/commitment information on a continuing scheduled basis is accomplished via event listeners.

3. The computer implemented method of claim 1, wherein reminding the user of the identified messages containing request/commitment information by sending push notifications, IM, SMS, electronic message or desktop notification to the user comprises sending a push notification, IM, SMS, electronic message or desktop notification to the user for each identified message containing request/commitment information based on the determination of whether the user has not responded to or otherwise acknowledged such electronic message.

4. The computer implemented method of claim 3, wherein the push notification, IM, SMS, electronic message or desktop notification comprises an option selected from the group consisting of an email server link, a web email link, a reply option and a real-time option.

5. The method according to claim 1, further comprising:
generating a list of electronic messages determined to contain request/commitment information; and
embedding and displaying such list adjacent to and concurrently with the display of the full electronic message body in the host messaging application.

6. The method according to claim 1, wherein comparing includes performing one-to-one pattern matching.

7. The method according to claim 1, wherein the request/commitment information components comprise one or more of the following: a signal, a modal phrase and a task.

8. The method according to claim 1, further comprising:
inserting an annotation into the electronic message corresponding to text determined to be a valid request/commitment information pattern, wherein the annotation is one or both of: a computer readable indicator or a visual indicator and wherein the annotation is an informational icon associated with an action menu.

9. The method according to claim 1, further comprising: ability to modify the default title of each electronic message contained in the list of electronic messages determined to contain request/commitment information via an editable text field.

10. The method according to claim 1, further comprising: ability to display the electronic messages contained in the list of electronic messages determined to contain request/commitment information according to a request/commitment information thread.

11. A system for determining valid request/commitment information patterns in text within an electronic message, said system comprising:
a processor, and
a memory coupled to the processor, said memory storing instructions to direct the processor to perform operations including accessing, from the memory, request/commitment information pattern having a set of request/commitment information components that define a predetermined pattern, said request/commitment information components being associated with a set of request/commitment information component criteria, comparing text in an electronic message with the request/commitment information components of the predetermined pattern, and determining valid request/commitment information patterns by identifying text that corresponds to the set of request/commitment information components of the predetermined pattern.

12. The system of claim 11, wherein the request/commitment information pattern, at least one set of request/commitment information components, or at least one set of request/commitment information component criteria are regular expressions.

13. A system for reminding a user of messages containing request/commitment information, comprising:
a processor; and
a set of memory resources storing a set of modules with routines executable by the processor, the set of modules having a request/commitment information processing module that may further include a request/commitment information component identification module to identify a user's messages as containing task-related information using a set of valid task-related information patterns and based on monitored message usage of the user;
a request/commitment information component pattern matching module; an action item module;
a task list generator module;
an interface module;
a message task completion determination module to identify whether a user has responded to or otherwise acknowledged a message containing request/commitment information; and
a notification module to notify or remind the user of messages containing request/commitment information via push notification, IM or SMS on the user's mobile device (e.g., phone, smartphone, smartwatch and other wearable technology or other push notification-enabled appliance) or via electronic message or desktop notification.

14. The system of claim 13, wherein the message request/commitment information identification module comprises routines to extract attributes that are used to determine whether an electornic message contains request/commitment information.

15. The system of claim 13, wherein the extracted electronic message attributes comprise electronic message attributes selected from the group consisting of attributes relating to a status of an electronic message received by the user, attributes relating to a sender of a user's electronic message, attributes capturing message information, attributes relating to message content, attributes capturing a reading event, attributes capturing a sending event and attributes capturing request/commitment information.

16. The system of claim 13, wherein the list generator module comprises a set of routines to determine which identified messages containing request/commitment information are to be included in a list of the valid request/commitment items.

17. A non-transitory computer readable medium comprising instructions executable by a processor to: extract message attributes when a new message arrives in a user's inbox or extract message attributes when a new message is sent from a user's outbox; determine whether the new or sent message contains request/commitment information based on the extracted attributes; and if the new or sent message is determined to contain request/commitment information:
assign suggested completion condition for the task-related message; monitor interactions of the user with the task-related message;
refine the determination that the message contains request/commitment information based on the monitored interactions; and
send a push notification, IM, SMS, electronic message or desktop notification to the user according to the suggested completion condition.

18. The non-transitory computer readable medium of claim 17, further comprising instructions to determine whether the completion condition has been fulfilled.

19. The non-transitory computer readable medium of claim 18, further comprising running an electronic message notification cron job periodically to determine when to send out a push notification, IM, SMS, electronic message or desktop notification to the user.

20. The system of claim 13, wherein the notification module comprises a set of routines to determine which identified messages containing task-related information are set to be notified to the user, wherein the identified messages that are set to be notified to the user are stored in a notification database.
